(19) United States
(12) Patent Application Publication
(10) Pub. No.: US 2010/0201615 A1
(43) Pub. Date: Aug. 12, 2010

(54) Touch and Bump Input Control

(76) Inventors: David John TUPMAN, Cupertino, CA (US); Tang Yew Tan, Cupertino, CA (US); Richard Hung Minh Dinh, Cupertino, CA (US); Stephen Paul Zadesky, Cupertino, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/370,457

(22) Filed: Feb. 12, 2009

(51) Int. Cl. G09G 5/00

(52) U.S. Cl. 345/156

(57) ABSTRACT

A touch and motion sensitive input control configured to use a combination of touch sensor output and motion sensor output to determine if an input event has occurred at an input area. The touch and motion sensitive input control can detect a particular input event (e.g., a button press) when a touch sensor detects a touch at a particular input area at around the same time as a motion sensor detects a change in motion. Based on the amount and nature of the motion detected, this can indicate that a user intended to cause an input event other than one caused by a mere touching of the input area.

### FIELD OF THE DISCLOSURE

This relates generally to input devices, and more particularly, to enhancing input discrimination of input devices using touch and motion sensors.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Touch sensitive input devices generally recognize input events when a user touches a touch sensitive surface. Touch sensitive input devices using capacitive touch technology can detect an input event with virtually no force, while other touch sensing technologies (e.g., resistive touch technology) require a somewhat greater amount of force. In contrast, mechanical input devices, such as push buttons for example, generally do not recognize input events unless a user taps or presses the mechanical input device with an amount of force great enough to actuate a switch through mechanical motion. This amount of force is generally greater than the amount of force that would trigger recognition of an input event on a capacitive of resistive touch sensitive surface.

Accordingly, mechanical input devices can be advantageous in that a user is not likely to cause a false push button event by merely touching the push button. However, mechanical input devices tend to occupy more space in devices than touch sensitive input devices. Mechanical input devices can also be less durable than touch sensitive input devices. For example, spacing between a mechanical input device and its supporting housing that enables its mechanical motion can expose the mechanical input device to external particles, such as dust and dirt, that can cause failure of the mechanical input device. Further, openings in a device housing that accommodate a mechanical input device can cause structural weakness or stress points in the device housing.

### SUMMARY OF THE DISCLOSURE

A touch and motion sensitive input control is disclosed. The touch and motion sensitive input control can use a combination of touch sensor output and motion sensor output to determine if an input event has occurred at an input area of a device held by a user.

By utilizing a combination of touch and motion sensors for detecting input, devices can be configured to be smaller, more durable and stronger than those with mechanical input devices. Touch sensors and motion sensors generally occupy less space than mechanical input devices due to a lack of moving parts, which can allow for a reduced device size. Touch sensors and motion sensors can also operate from inside of a device housing. This can reduce the need for openings to be created in the housing which can lead to structural weakness, and reduce entryways for external contaminants which can lead to input device failure.

A touch and motion sensitive input control can detect a particular input event (e.g., a button press) when a touch sensor detects a touch at a particular input area at around the same time as a motion sensor detects a change in motion. Based on the amount and nature of the motion detected, this can indicate that a user intended to cause an input event other than one caused by a mere touching of the input area.

In one example, when the input area is a non-display touch and motion sensitive surface, the touch and motion sensitive input control can be configured to ignore touches but recognize taps or other motion-based input at the input area. This can avoid incidental contact with the touch and motion sensitive input area from being recognized as an input event. In another example, when the input area is a display-based motion sensitive touch screen, the touch and motion sensitive input control can be configured to recognize both touches and taps (or other motion-based input), discriminate between them, and associate distinct input events to each type of input.

### BRIEF DESCRIPTION OF THE DRAWINGS

FIG. 1 illustrates an exemplary handheld computing device with touch and motion sensitive input areas according to an embodiment of the invention.

FIG. 2 illustrates an exemplary process in which a handheld computing device can determine whether a touch and motion activated input event has occurred according to an embodiment of the invention.

FIG. 3 illustrates an exemplary process in which a handheld computing device can determine whether a touch activated input event or a touch and motion activated input event has occurred according to an embodiment of the invention.

FIG. 4 illustrates an exemplary cross-section of one side of a housing enabling a touch and motion sensitive input area according to an embodiment of the invention.

FIG. 5 illustrates an exemplary cross-section of one side of a housing enabling a touch and motion sensor input area according to another embodiment of the invention.

FIG. 6 illustrates an exemplary cross-section of one side of a housing enabling a touch and motion sensitive input area according to another embodiment of the invention.

FIG. 7 illustrates an exemplary handheld computing device according to an embodiment of the invention.

FIG. 8 illustrates an exemplary handheld computing device including a multi-touch sensor panel according to an embodiment of the invention

FIG. 9 illustrates an exemplary mobile telephone providing a touch and motion sensitive input area according to an embodiment of the invention.

FIG. 10 illustrates an exemplary media player providing a touch and motion sensitive input area according to an embodiment of the invention.

### DETAILED DESCRIPTION OF THE PREFERRED EMBODIMENTS

In the following description of preferred embodiments, reference is made to the accompanying drawings where it is shown by way of illustration specific embodiments in which the invention can be practiced. It is to be understood that other embodiments can be used and structural changes can be made without departing from the scope of the embodiments of this invention.

Embodiments of the invention relate to using a combination of touch sensor output and motion sensor output to determine if an input event has occurred at an input area. Devices that utilize this combination of sensors for detecting input can be configured to be smaller, more durable and stronger than those with mechanical input devices. Touch sensors and motion sensors generally occupy less space than mechanical input devices due to a lack of moving parts, and can operate from inside of a device housing, reducing the need for openings to be created in the housing, which can lead to structural weakness, and reducing entryways for external contaminants, which can lead to input device failure.

Although some embodiments of this invention may be described and illustrated herein in terms of handheld computing devices, it should be understood that embodiments of this invention are not so limited, but are generally applicable to any device, system or platform, configured for receiving touch input, that moves, even to a small degree, when tapped. Further, although some embodiments of this invention may be described and illustrated herein in terms of a tap causing the requisite type of movement to trigger a touch and motion based input event, it should be understood that embodiments of this invention are not so limited, but are generally applicable to any type of touch input (e.g., tap and hold, press, etc.) that causes the device to move in a predictable manner that can be identified through motion analysis.

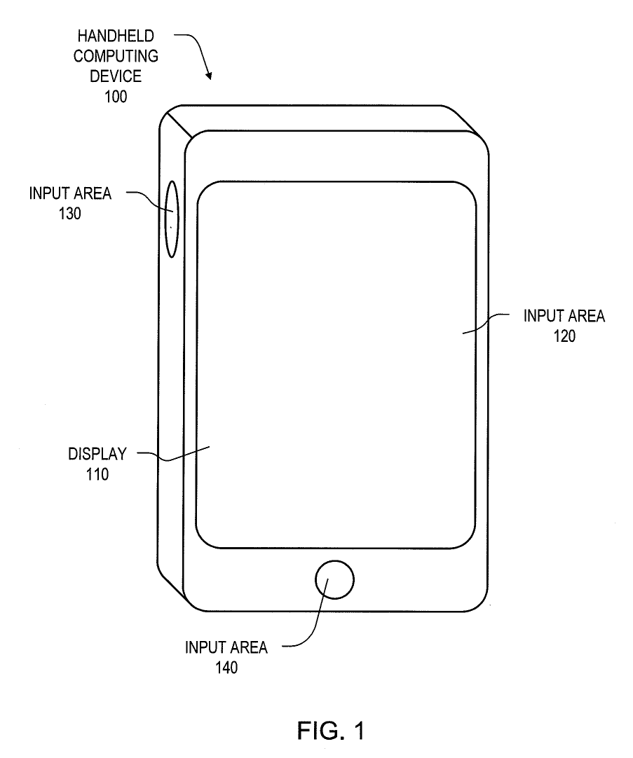

FIG. 1 illustrates handheld computing device 100 configured with touch and motion sensitive input areas. In the embodiment illustrated in FIG. 1, handheld computing device 100 includes display 110 and touch and motion sensitive input areas 120, 130 and 140. Input area 120 can include a touch screen input device, and input areas 130 and 140 can include touch sensitive surfaces of the device housing. Handheld computing device 100 can also include one or more motion sensors (not shown) inside the housing. The general shape of handheld computing device 100 is not intended to be limiting in any manner, and is depicted in a box-like fashion for ease of illustration. It should be appreciated that handheld computing device 100 can take any suitable shape and size, with different dimensions and roundedness for example, and that touch and motion sensitive input areas can be located in any suitable location on handheld computing device 100.

The touch and motion sensitive input areas enable handheld computing device 100 to detect a particular input event (e.g., a button press) when a touch sensor detects a touch at a particular input area at around the same time as a motion sensor detects a change in motion. Based on the amount and nature of the motion detected, this can indicate that a user has tapped the input area rather than merely touched it, indicating an intent to cause the particular input event at the input area.

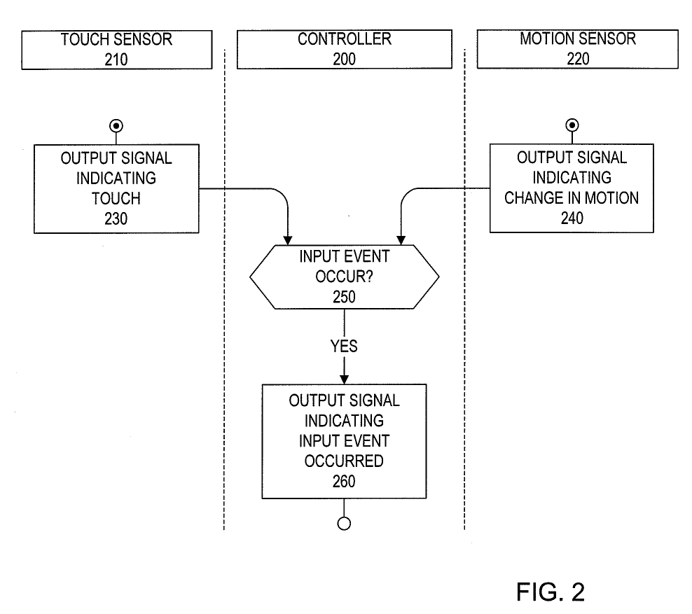

FIG. 2 illustrates a process in which handheld computing device 100 can determine whether a touch and motion activated input event has occurred. In the embodiment illustrated in FIG. 2, handheld computing device 100 includes touch sensor 210, motion sensor 220 and controller 200. When an object touches, or comes in close proximity to, a particular input area, touch sensor 210 can be configured to output (block 230) a signal to controller 200 indicating a touch condition. When handheld computing device 100 is moved, motion sensor 220 can be configured to output (block 240) a signal to controller 200 indicating a change in motion condition. Upon receiving the touch and motion output, controller 200 can determine (block 250) whether an input event occurred at the particular input area based on the nature of the detected touch and the detected change in motion. If an input event is determined to have occurred, controller 200 can output (block 260) a signal indicating that an input event occurred at the particular input area. The output signal can be directed to a host processor of handheld computing device 100, for example, which can implement a function associated with the particular input area in response to the input event.

This embodiment can be particularly advantageous when touch sensor 210 is a non-display touch sensitive surface. In this manner, controller 200 ignores touches but recognizes taps at a particular touch and motion sensitive input area, which avoids incidental contact with the touch and motion sensitive input area from being recognized as an input event.

The manner in which controller 200 can determine that an input event has occurred can be widely varied. For example, in one embodiment, controller 200 can determine that an input event has occurred when the touch sensor output indicates a fresh touch (i.e., a touch condition following a no-touch condition within a short period of time) at around the same time as the motion sensor output indicates that the change in motion met or exceeded a threshold level in the direction of force to be applied to the particular input area to trigger an input event. This threshold level can be calibrated during factory testing or by user initialization to define a pattern of motion change of handheld computing device 100 (e.g., a bell-shaped curve) to indicate that a user has tapped, and not merely touched, the particular input area with an intent to cause an input event at that particular input area. In this embodiment, motion sensor 220 can be configured to output real-time or near real-time motion change data to controller 200, so that controller 200 can determine whether the predefined pattern of motion change data received from motion sensor 220 indicates a tap, rather than a mere touch or device motion caused by other reasons (e.g., a user walking with handheld computing device 100 in pocket, the picking up or putting down of handheld computing device 100, etc.).

In another embodiment, motion sensor 220 can include some processing capability. With processing capability, motion sensor 220, rather than controller 200, can be configured to perform the motion change pattern analysis. Motion sensor 220 can be also configured to output a signal to controller 200 (in block 240) only when a positive result indicating a tap has been determined. This embodiment can reduce the processing burden for controller 200, but may result in a motion sensor of a larger size to accommodate the additional processing circuitry.

The manner in which controller 200 can synchronize the outputs of touch sensor 210 and motion sensor 220 can be widely varied. In one embodiment, controller 200 can be configured to check motion sensor output only after receiving an indication of a touch from the touch sensor output. This can conserve processing time and power in embodiments in which controller 200 is configured to perform the motion change pattern analysis, especially if handheld computing device 100 is more likely to be moved around than touched in a particular touch and motion sensitive input area.

In another embodiment, controller 200 can be configured to check touch sensor output only after receiving an indication of motion change from the motion sensor output. This can conserve processing time and power in embodiments in which motion sensor 220 is configured to perform the motion change pattern analysis, especially if handheld computing device 100 is more likely to be touched in a particular touch and motion sensitive input area than tapped in a manner indicating input event. In both embodiments, controller 200 can store recent output from either of touch sensor 210 or motion sensor 220, or both, in registers so that it can appropriately determine that the touch and motion change occurred at around the same time.

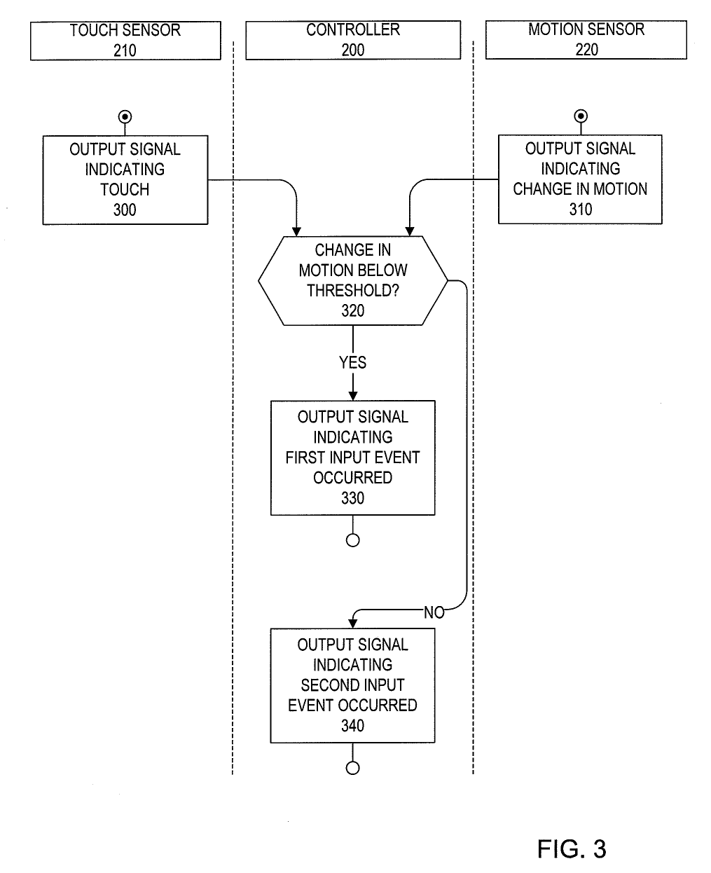

FIG. 3 illustrates a process in which handheld computing device 100 can determine whether a touch activated input event, or a touch and motion activated input event, has occurred. Similar to block 230 in FIG. 2, when an object touches, or comes in close proximity to, a particular input area, touch sensor 210 can be configured to output (block 300) a signal to controller 200 indicating a touch condition. Similar to block 240 in FIG. 2, when handheld computing device 100 is moved, motion sensor 220 can be configured to output (block 310) a signal to controller 200 indicating a change in motion condition. Upon receiving the touch and motion output, controller 200 can determine (block 320) whether the motion sensor output indicates that the change in motion fell below a threshold level as described above. If the threshold was not reached, then controller 200 can output (block 330) a signal indicating that a particular input event occurred at the particular input area. If the threshold was met or exceeded, then controller 200 can output (block 340) a signal indicating that a different input event occurred at the particular input area.

This embodiment can be particularly advantageous when touch sensor 210 is a touch screen in which a user interface is displayed at a particular touch and motion sensitive input area. In this manner, instead of ignoring touches and recognizing taps at a particular touch and motion sensitive input area as described in the embodiment of FIG. 2, controller 200 in the embodiment of FIG. 3 can recognize both touches and taps, discriminate between them, and associate distinct input events to each type of input. For example, a touch applied to a user interface object (e.g., a menu icon) displayed on a touch screen in accordance with this embodiment could enable a user to select the object (similar to a single click of a traditional mouse pointing device, for example), whereas a tap applied to the user interface object could enable the user to activate a command associated with the object (similar to a double click of a traditional mouse pointing device, for example).

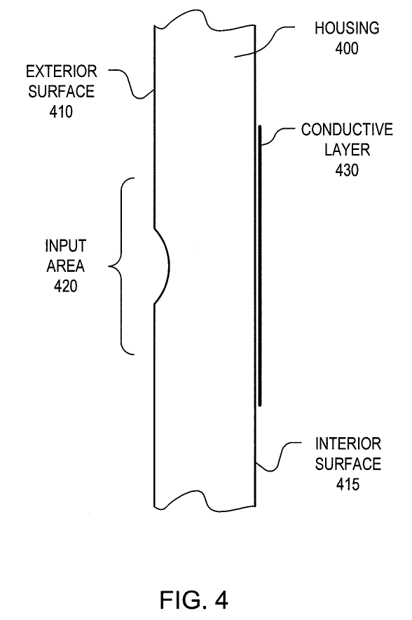

FIGS. 4-6 illustrate different configurations of touch and motion sensitive input areas. For example, in the embodiment illustrated in FIG. 4, a cross-section of one side of housing 400 comprises exterior surface 410, interior surface 415, input area 420 and conductive layer 430. Exterior surface 410 can be marked in any suitable manner to indicate the location of input area 420 on housing 400, such as by indentation (as illustrated) or by laser etching, for example. Conductive layer 430 can comprise any conductive material, such as indium tin oxide (ITO) for example, and can be deposited directly on interior surface 415 opposite exterior surface 410. In the embodiment illustrated in FIG. 4, conductive layer 430 can act as a pad electrode for a capacitive touch sensor associated with input area 420. However, it should be understood that conductive layer 430 can be formed in any configuration or number of layers to enable a suitable touch sensitive surface for input area 420. Housing 400 can be made of plastic in the region of input area 420, serving as a rigid surface and a dielectric for the capacitive touch sensor. A motion sensor associated with input area 420 (not shown) can be mounted to housing 400 or any suitable component therein where space allows.

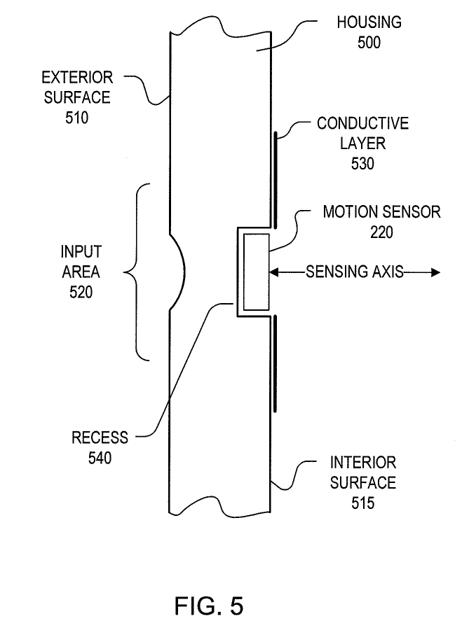

In the embodiment illustrated in FIG. 5, a cross-section of one side of housing 500 comprises exterior surface 510, interior surface 515, input area 520, conductive layer 530, recess 540 and motion sensor 220. Recess 540 can be etched into housing 500 to accommodate motion sensor 220, and conductive layer 530 can be deposited directly on a surface of housing 500 opposite exterior surface 510 and around recess 540. Motion sensor 220 can be a one-axis accelerometer, and, in order to ensure proper detection, can be mounted such that the sensing axis is aligned with the direction of force to be applied to input area 520 to trigger an input event. A multi-axis accelerometer can also be used, but may be larger in size than the one-axis accelerometer and thus occupy more space.

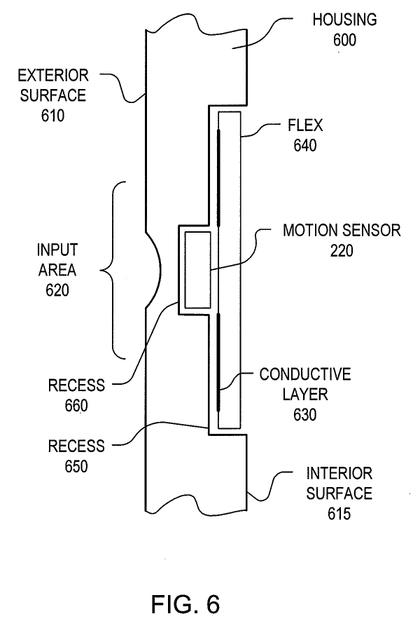

In the embodiment illustrated in FIG. 6, a cross-section of one side of housing 600 comprises exterior surface 610, interior surface 615, input area 620, conductive layer 630, flexible printed circuit board (flex) 640, recesses 650 and 660, and motion sensor 220. Motion sensor 220 and conductive layer 630 can be arranged on flex 640 and installed in recesses 650 and 660, which can be configured to accommodate motion sensor 220 and conductive layer 630, respectively.

The arrangement of touch sensor 210, motion sensor 220 and controller 200 within handheld computing device 100 can be widely varied. For example, as illustrated in FIGS. 5-6, motion sensor 220 can be dedicated to detecting changes in motion only in connection with a corresponding determination that an input event occurred at one particular input area. In other embodiments, as described in connection with FIG. 4, motion sensor 220 can be located apart from any particular input area, and detect changes in motion in connection with multiple input areas or other purposes, such as motion-based application programming executed by handheld computing device 100.

The embodiments illustrated above in connection with FIGS. 4-6 can be particularly advantageous for small devices, since the touch and motion sensors associated with the touch and motion sensitive input areas are configured to have a minimal footprint apart from the housing surface.

It should also be appreciated that the device housing reflected in the above embodiments can be made of a material other than plastic and still serve as a rigid surface in accordance with the teachings of the invention as disclosed above. For example, the device housing could be made of a rubber-like material, as long as the rubber-like material is firm enough to enable the motion sensor to detect a tap or other motion-based input besides one caused by a mere touching of the input area.

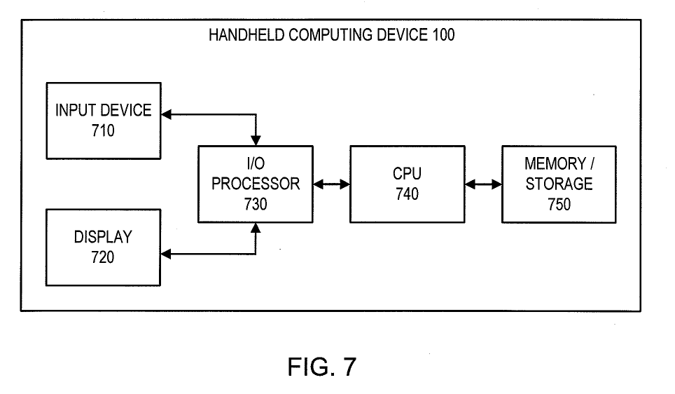

FIG. 7 illustrates exemplary handheld computing device 100 that can include one or more of the embodiments of the invention described above. Handheld computing device 100 can include input device 710, display 720, I/O processor 730, central processing unit (CPU) 740 and memory/storage 750. Programming for processing the input as described above may be stored in memory/storage 750 of handheld computing device 100, which may include solid state memory (RAM, ROM, etc.), hard drive memory, and/or other suitable memory or storage. CPU 740 may retrieve and execute the programming to process the input received through input device 710, which may include touch sensor 310, motion sensor 320 and controller 300 as described above and/or other input devices not shown. Through the programming, CPU 740 can receive outputs from input device 710 and perform actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, receiving a text message, sending a text message, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. CPU 740 can also perform additional functions that may not be related to input device processing, and can be coupled to memory/storage 750 and display 720, which may include a liquid crystal display (LCD) for example, for providing a user interface (UI) to a user of the device.

Note that one or more of the functions described above can be performed by firmware stored in a memory (not shown) associated with I/O processor 730 and executed by I/O processor 730, or stored in memory/storage 750 and executed by CPU 740. The firmware can also be stored and/or transported within any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any medium that can contain or store a program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

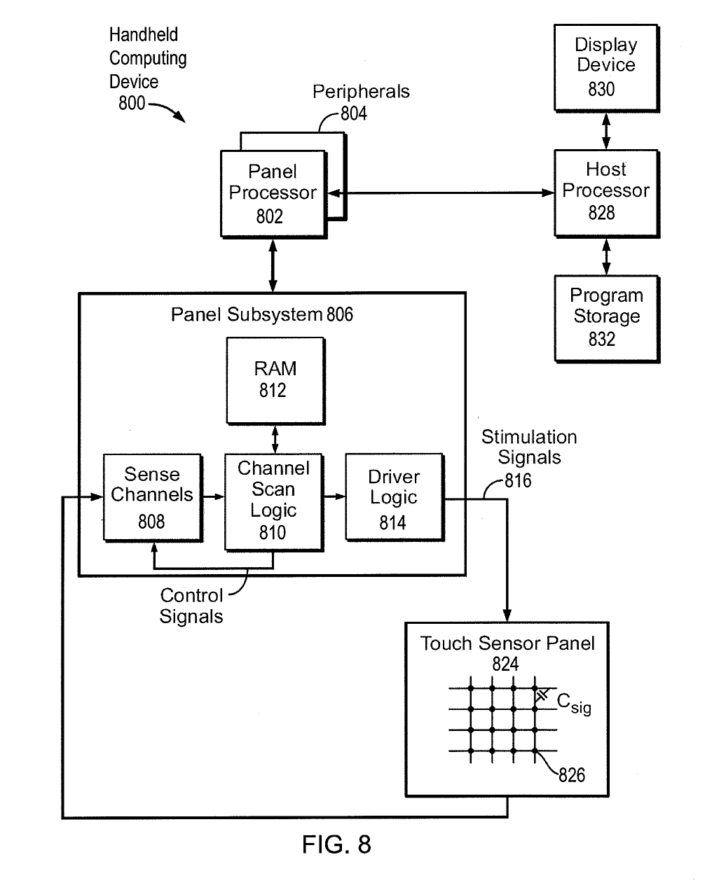

FIG. 8 illustrates exemplary handheld computing device 100 including a multi-touch sensor panel that can include one or more of the embodiments of the invention described above. Computing system 800 can include one or more panel processors 802 and peripherals 804, and panel subsystem 806 associated with a touch screen in input device as described above. Peripherals 804 can include, but are not limited to, random access memory (RAM) or other types of memory or storage, watchdog timers and the like. Peripherals 804 can also include touch sensor 310, motion sensor 320 and controller 300 as described above. Panel subsystem 806 can include, but is not limited to, one or more sense channels 808, channel scan logic 810 and driver logic 814. Channel scan logic 810 can access RAM 812, autonomously read data from the sense channels and provide control for the sense channels. In addition, channel scan logic 810 can control driver logic 814 to generate stimulation signals 816 at various frequencies and phases that can be selectively applied to drive lines of touch sensor panel 824. In some embodiments, panel subsystem 806, panel processor 802 and peripherals 804 can be integrated into a single application specific integrated circuit (ASIC).

Touch sensor panel 824 can include a capacitive sensing medium having a plurality of drive lines and a plurality of sense lines, although other sensing media can also be used. Each intersection of drive and sense lines can represent a capacitive sensing node and can be viewed as picture element (pixel) 826, which can be particularly useful when touch sensor panel 824 is viewed as capturing an “image” of touch. In other words, after panel subsystem 806 has determined whether a touch event has been detected at each touch sensor in the touch sensor panel, the pattern of touch sensors in the multi-touch panel at which a touch event occurred can be viewed as an “image” of touch (e.g., a pattern of fingers touching the panel). Each sense line of touch sensor panel 824 can drive sense channel 808 in panel subsystem 806. The touch sensor panel can be used in combination with a motion sensor to provide a touch and motion sensitive input area in accordance with the teachings of invention as disclosed above.

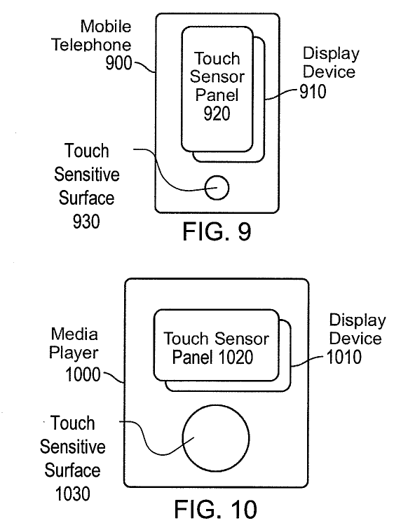

Handheld computing device 100 can be any of a variety of types, such as those illustrated in FIGS. 9 and 10 for example. FIG. 9 illustrates exemplary mobile telephone 900 with display device 910, touch sensor panel 920 and touch sensitive surface 930. Either touch sensor panel 920 or touch sensitive surface 930, or both, can be configured to provide a touch and motion sensitive input area in accordance with the teachings of invention as disclosed above. FIG. 10 illustrates exemplary media player 1000 with display device 1010, touch sensor panel 1020 and touch sensitive surface 1030. Either touch sensor panel 1020 or touch sensitive surface 1030, or both, can be configured to provide a touch and motion sensitive input area in accordance with the teachings of invention as disclosed above. Additionally, handheld computing device 100 may be a combination of these types. For example, in one embodiment handheld computing device 100 may be a device that combines functionality of mobile telephone 900 and media player 1000. Touch and motion sensitive input areas can enable the mobile telephone and media player of FIGS. 9 and 10 to be configured smaller, more durable and stronger than those with mechanical input devices.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A method comprising:
detecting a touch applied to an input area of a handheld computing device;
detecting a change in motion of the handheld computing device; and
determining whether an input event occurred at the input area based on the detected touch and the detected change in motion.

2. The method of claim 1, wherein determining whether the input event occurred includes
determining whether the touch was applied to the input area at around the same time as the detection of the change in motion.

3. The method of claim 2, wherein determining whether the input event occurred further includes
determining whether the change in motion meets or exceeds a threshold level.

4. The method of claim 1, further including
implementing a function associated with the input area if the input event is determined to have occurred at the input area.

5. A method of claim 1, wherein determining whether the input event occurred includes
determining that a first input event occurred at the input area if the detected change in motion falls below a threshold level; and
determining that a second input event occurred at the input area if the detected change in motion meets or exceeds the threshold level.

6. The method of claim 6, wherein the input area of the handheld computing device is associated with a touch screen.

7. The method of claim 6, further including
implementing a first function associated with a user interface displayed at the input area if the first input event is determined to have occurred at the input area; and
implementing a second function associated with the user interface displayed at the input area if the second input event is determined to have occurred at the input area.

8. The method of claim 7, wherein
the first function enables a user of the handheld computing device to select an object displayed at the input area if the first input event is determined to have occurred at the input area.

9. The method of claim 7, wherein
the second function enables a user of the handheld computing device to activate a command associated with an object displayed at the input area if the second input event is determined to have occurred at the input area.

10. The method of claim 5, wherein the first input event includes a touch event, and the second input event includes a tap event.

11. A handheld computing device comprising:
a touch sensor configured to detect a touch applied to an input area of the handheld computing device;
a motion sensor configured to detect a change in motion of the handheld computing device; and
a controller configured to determine whether an input event occurred at the input area based on an output of the touch sensor and an output of the motion sensor.

12. The device of claim 11, wherein the handheld computing device is configured to utilize the motion sensor only in connection with a corresponding determination that an input event occurred at the input area.

13. The device of claim 12, wherein the motion sensor comprises a one-axis accelerometer.

14. The device of claim 11, wherein the handheld computing device is configured to utilize the motion sensor in connection with motion-based application programming executed by the handheld computing device.

15. The device of claim 14, wherein the motion sensor comprises a three-axis accelerometer.

16. The device of claim 11, wherein the handheld computing device further includes a touch screen, and the controller is configured to determine whether an input event occurred at a location on the touch screen.

17. The device of claim 11, wherein the handheld computing device is a mobile telephone.

18. The device of claim 11, wherein the handheld computing device is a media player.

19. The device of claim 11, wherein the input area is a touch and motion sensitive surface not associated with a display.

20. The device of claim 11, wherein the input area of the handheld computing device is associated with a rigid surface.

21. The device of claim 11, wherein the input area of the handheld computing device is associated with a touch screen.

22. A touch and motion sensitive surface comprising:
a substrate;
an input area on a first side of the substrate;
a conductive layer on a second side of the substrate opposite the first side and the input area; and
a motion sensing element embedded in the substrate on the second side opposite the first side and the input area.

23. The device of claim 22, wherein the motion sensing element is mounted in a recess of the substrate.

24. The device of claim 22, wherein the first side of the substrate is an external surface of a handheld computing device.

25. The device of claim 22, wherein the conductive layer is a pad electrode.
